(19) United States
(12) Patent Application Publication
(10) Pub. No.: US 2023/0023749 A1
(43) Pub. Date: Jan. 26, 2023

(54) Roofing Materials With Improved Impact Resistance and Methods of Making Thereof

(71) Applicant: BMIC LLC, Dallas, TX (US)

(72) Inventors: Denis Tibah, Waxahachie, TX (US); John MacKinnon, Grapevine, TX (US); Kevin Carr, Dallas, TX (US); Emily Tenney, York, SC (US); Sami Abounassif, Dallas, TX (US)

(21) Appl. No.: 17/873,433

(22) Filed: Jul. 26, 2022

Related U.S. Application Data
(60) Provisional application No. 63/225,592, filed on Jul. 26, 2021.

(51) Int. Cl. E04D 1/20; C03C 25/255

(52) U.S. Cl. CPC E04D 1/20; C03C 25/255; E04D 2001/005

(57) ABSTRACT

This invention, in embodiments, relates to a roll comprising a fiberglass mat. The fiberglass mat includes a plurality of fibers, with the plurality of fibers including (i) a first set of fibers extending in a machine direction of the roll, and (ii) a second set of fibers extending in a transverse direction of the roll. The fiberglass mat has a basis weight of 1.6 lbs/csf to 2.2 lbs/csf, and the fiberglass mat has a tensile strength in the machine direction of the roll and a tensile strength in the transverse direction of the roll, such that a ratio of the tensile strength in the machine direction of the roll relative to the tensile strength in the transverse direction of the roll is from 1:1 to 3:1. The fiberglass mat is coated and a roofing material formed with the coated fiberglass mat has a mean failure energy according to ASTM D5420 of 2 in-lbs to 4.5 in-lbs.

This application claims the priority of U.S. provisional application Ser. No. U.S. 63/225,592, entitled “Roofing Materials With Improved Impact Resistance And Methods of Making Thereof” filed Jul. 26, 2021, which is incorporated herein by reference in its entirety for all purposes.

### FIELD OF THE INVENTION

This invention relates to roofing materials with improved impact resistance and methods of making such roofing materials. The roofing materials include a substrate having a range of basis weights and including fibers that comprise (i) a first set of fibers extending in a machine direction of a roll of the substrate, and (ii) a second set of fibers extending in a transverse direction of the roll of the substrate, such that the substrate has a range of ratios of tensile strength in the machine direction relative to tensile strength in the transverse direction and/or a number of fibers extending in the machine direction relative to a number of fibers extending in the transverse direction. Roofing materials, such as, e.g., shingles, prepared from this substrate exhibit superior properties of, for example, increased mean failure energy and/or impact resistance, as compared to roofing materials without such a substrate.

### BACKGROUND OF THE INVENTION

Typically, roofing materials, such as, e.g., shingles, are based upon a fiberglass or felt mat that is coated and impregnated with an asphalt-based composition that is subsequently coated with granules. Air blown asphalt and polymer-modified asphalt have been used as roofing shingle coating materials for many years. However, such roofing materials do not always exhibit the necessary mechanical strength and/or impact resistance for various applications.

There is therefore a need for roofing materials that exhibit superior properties of, for example, increased mean failure energy and/or impact resistance.

### SUMMARY OF THE INVENTION

One embodiment of this invention pertains to a roll comprising a fiberglass mat. The fiberglass mat comprises a plurality of fibers, with the plurality of fibers comprising (i) a first set of fibers extending in a machine direction of the roll, and (ii) a second set of fibers extending in a transverse direction of the roll. The fiberglass mat has a basis weight of 1.6 lbs/csf to 2.2 lbs/csf, and the fiberglass mat has a tensile strength in the machine direction of the roll and a tensile strength in the transverse direction of the roll, such that a ratio of the tensile strength in the machine direction of the roll relative to the tensile strength in the transverse direction of the roll is from 1:1 to 3:1. When the fiberglass mat is coated with at least one of asphalt, a polymer-modified asphalt, or a non-asphaltic polymeric coating to form a roofing material, the roofing material has a mean failure energy according to ASTM D5420 of 2 in-lbs to 4.5 in-lbs.

In one embodiment, the roofing material has a mean failure energy of 2.5 in-lbs to 4 in-lbs. According to another embodiment, the roofing material has a mean failure energy of 2.6 in-lbs to 3.8 in-lbs.

In one embodiment, the fiberglass mat has a basis weight of 1.8 lbs/csf to 2.15 lbs/csf.

In one embodiment, the fibers further comprise a third set of fibers extending in a third direction that is between the machine direction of the roll and the transverse direction of the roll.

Another embodiment of this invention pertains to a roll comprising a fiberglass mat. The fiberglass mat comprises a plurality of fibers, with the plurality of fibers comprising (i) a first set of fibers extending in a machine direction of the roll, and (ii) a second set of fibers extending in a transverse direction of the roll. The fiberglass mat has a basis weight of 1.6 lbs/csf to 2.2 lbs/csf, and the fiberglass mat has a ratio of the number of fibers of the first set of fibers extending in the machine direction of the roll relative to the number of fibers of the second set of fibers extending in the transverse direction of the roll of from 1:1 to 3:1. When the fiberglass mat is coated with at least one of asphalt, a polymer-modified asphalt, or a non-asphaltic polymeric coating to form a roofing material, the roofing material has a mean failure energy according to ASTM D5420 of 2 in-lbs to 4.5 in-lbs

In one embodiment, the roofing material has a mean failure energy of 2.5 in-lbs to 4 in-lbs. According to another embodiment, the roofing material has a mean failure energy of 2.6 in-lbs to 3.8 in-lbs.

In one embodiment, the fiberglass mat has a basis weight of 1.8 lbs/csf to 2.15 lbs/csf.

In one embodiment, the fibers further comprise a third set of fibers extending in a third direction that is between the machine direction of the roll and the transverse direction of the roll.

Another embodiment of this invention pertains to a roofing material comprising (a) a substrate including fibers, wherein the fibers comprise (i) a first set of fibers extending in a machine direction of a roll of the substrate, and (ii) a second set of fibers extending in a transverse direction of the roll of the substrate, with the substrate having a tensile strength in the machine direction of the roll and a tensile strength in the transverse direction of the roll, such that a ratio of the tensile strength in the machine direction relative to the tensile strength in the transverse direction is from 1:1 to 3:1, and (b) a coating is applied onto the substrate, thereby forming a coated substrate. The substrate, prior to coating (i.e., the uncoated substrate), has a basis weight of 1.6 lbs/csf to 2.2 lbs/csf, and the roofing material has a mean failure energy according to ASTM D5420 of 2 in-lbs to 4.5 in-lbs.

In one embodiment, the roofing material has a mean failure energy of 2.5 in-lbs to 4 in-lbs. According to another embodiment, the roofing material has a mean failure energy of 2.6 in-lbs to 3.8 in-lbs.

In one embodiment, the substrate has a basis weight of 1.8 lbs/csf to 2.15 lbs/csf.

In one embodiment, the fibers further comprise a third set of fibers extending in a third direction that is between the machine direction of the roll and the transverse direction of the roll.

In an embodiment, the substrate comprises at least one of a scrim, a fiberglass mat or a polyester mat.

In an embodiment, the coating comprises at least one of asphalt, a polymer-modified asphalt, or a non-asphaltic polymeric coating.

In one embodiment, the coating at least partially infiltrates the substrate.

In one embodiment, the roofing material further comprises a second substrate. According to an embodiment, the coating is applied onto both the substrate and the second substrate, thereby forming the coated substrate and a coated second substrate. According to another embodiment, a polymer-based coating layer is positioned between the substrate and the second substrate. According to an embodiment, the coating is applied onto the substrate, the second substrate, and the polymer-based coating layer, thereby forming the coated substrate, a coated second substrate, and a coated polymer-based coating layer. According to another embodiment, the second substrate comprises at least one of a scrim, a fiberglass mat or a polyester mat.

In an embodiment, the roofing material is a roofing shingle. According to one embodiment, the roofing shingle is one of (i) a single layer shingle or (ii) a laminated shingle having two or more layers.

In one embodiment, the roofing material further comprises granules. In another embodiment, the roofing material further comprises fines. According to another embodiment, granules are applied to a first side of the coated substrate and fines are applied to a second side of the coated substrate.

Another embodiment of this invention pertains to a method of preparing a roofing material that includes (a) obtaining a substrate including fibers, wherein the fibers comprise (i) a first set of fibers extending in a machine direction of a roll of the substrate, and (ii) a second set of fibers extending in a transverse direction of the roll of the substrate, with the substrate having a tensile strength in the machine direction of the roll and a tensile strength in the transverse direction of the roll, such that a ratio of the tensile strength in the machine direction relative to the tensile strength in the transverse direction is from 1:1 to 3:1, and (b) applying a coating onto the substrate to form a coated substrate of the roofing material. The substrate, prior to coating (i.e., the uncoated substrate), has a basis weight of 1.6 lbs/csf to 2.2 lbs/csf, and the roofing material has a mean failure energy according to ASTM D5420 of 2 in-lbs to 4.5 in-lbs.

In an embodiment, the substrate comprises at least one of a scrim, a fiberglass mat or a polyester mat.

In an embodiment, the coating comprises at least one of asphalt, a polymer-modified asphalt, or a non-asphaltic polymeric coating.

In one embodiment, the coating at least partially infiltrates the substrate.

In one embodiment, the method further includes obtaining a second substrate.

According to an embodiment, the coating is applied onto both the substrate and the second substrate, thereby forming the coated substrate and a coated second substrate. According to another embodiment, a polymer-based coating layer is positioned between the substrate and the second substrate. According to an embodiment, the coating is applied onto the substrate, the second substrate, and the polymer-based coating layer, thereby forming the coated substrate, a coated second substrate, and a coated polymer-based coating layer. According to another embodiment, the second substrate comprises at least one of a scrim, a fiberglass mat or a polyester mat.

In one embodiment, the fibers further comprise a third set of fibers extending in a third direction that is between the machine direction of the roll and the transverse direction of the roll.

In an embodiment, the roofing material is a roofing shingle. According to one embodiment, the roofing shingle is one of (i) a single layer shingle or (ii) a laminated shingle having two or more layers.

In one embodiment, the method further includes applying granules to the coated substrate. In another embodiment, the method further includes (i) applying granules to a first side of the coated substrate and (ii) applying fines to a second side of the coated substrate.

### BRIEF DESCRIPTION OF THE FIGURES

For a more complete understanding of the invention and the advantages thereof, reference is made to the following descriptions, taken in conjunction with the accompanying figures, in which:

FIG. 1 is an illustration of the machine direction and the transverse direction of a roll of substrate according to an embodiment of the invention.

FIG. 2A is an illustration of a roofing material comprising a substrate according to an embodiment of the invention.

FIG. 2B is an illustration of a roofing material comprising two substrates according to an embodiment of the invention.

FIG. 2C is an illustration of a roofing material comprising two substrates and a polymer-based coating layer according to an embodiment of the invention.

FIG. 3 is a graph illustrating various samples and their respective mean failure energy values (in-lbs) according to an embodiment of the invention.

FIGS. 4A-4C are photographs of prepared asphalt coated mats and/or scrims according to embodiments of the invention.

FIGS. 5A and 5B are photographs of prepared lab shinglet prototypes according to an embodiment of the invention.

FIG. 6 is a table illustrating various samples and their respective failure values according to embodiments of the invention.

FIG. 7 is a photograph of prepared roofing materials after testing for failure according to an embodiment of the invention.

FIG. 8 is a table illustrating various samples and their respective mean failure energy values (in-lbs) according to embodiments of the invention.

### DETAILED DESCRIPTION OF THE INVENTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though they may. Furthermore, the phrases “in another embodiment” and “in some other embodiments” as used herein do not necessarily refer to a different embodiment, although they may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, terms such as “comprising,” “including,” and “having” do not limit the scope of a specific claim to the materials or steps recited by the claim.

As used herein, terms such as “consisting of” and “composed of” limit the scope of a specific claim to the materials and steps recited by the claim.

All prior patents, publications, and test methods referenced herein are incorporated by reference in their entireties.

As used herein, the term “coated substrate” means a substrate that is coated on one side (upper surface or lower surface) or both sides (upper surface and lower surface) with a coating that includes, for example, an asphaltic coating, a non-asphaltic coating, and/or a polymer-modified asphalt coating.

As used herein, the term “uncoated substrate” means a substrate that has not been coated on any side (upper surface and/or lower surface) with a coating that includes, for example, an asphaltic coating, a non-asphaltic coating, and/or a polymer-modified asphalt coating.

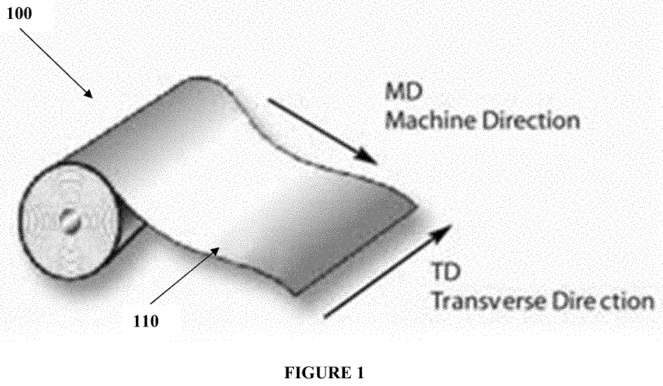

As used herein, the term “machine direction” means the direction that a substrate and/or a fiberglass mat is wrapped around itself to create a roll during the manufacturing of the substrate and/or the fiberglass mat, which is the “machine direction” (MD) as illustrated in FIG. 1.

As used herein, the term “transverse direction” means the direction of a substrate and/or a fiberglass mat that is perpendicular to the “machine direction,” as described above, which is the “transverse direction” (TD) as illustrated in FIG. 1.

As used herein, the term “directionality” refers to the amount of fibers that a substrate has in one direction as compared to another direction, e.g., machine direction versus transverse direction. A substrate that has a “high directionality” means a substrate with more fibers in one direction, e.g., the machine direction, as compared to another direction, e.g., the transverse direction. A substrate with “no directionality” or a “low directionality” means a substrate with substantially the same amount (or an even distribution) of fibers in both directions, e.g., the machine direction and the transverse direction.

As used herein, the term “roofing material” includes, but is not limited to, shingles, waterproofing membranes, underlayment, and tiles.

One embodiment of this invention pertains to a roll comprising a substrate and/or a mat, such as, e.g., a fiberglass mat. The substrate and/or fiberglass mat comprises a plurality of fibers, with the plurality of fibers comprising (i) a first set of fibers extending in a machine direction of the roll, and (ii) a second set of fibers extending in a transverse direction of the roll.

FIG. 1 illustrates a roll (100) comprising a substrate and/or a fiberglass mat (110) according to an embodiment of the invention. In this embodiment, the roll (100) includes a machine direction (MD), as shown in FIG. 1, and a transverse direction (TD), as also shown in FIG. 1, which is perpendicular to the machine direction (MD). As discussed above, the substrate and/or fiberglass mat (110) comprises a plurality of fibers, with the plurality of fibers comprising (i) a first set of fibers extending in the machine direction (MD) of the roll (100), and (ii) a second set of fibers extending in the transverse direction (TD) of the roll (100).

In an embodiment, the substrate and/or fiberglass mat (see, e.g., substrate or fiberglass mat (110) of FIG. 1) has a basis weight of 1.6 lbs/csf to 2.2 lbs/csf. In one embodiment, the substrate and/or fiberglass mat has a basis weight of 1.7 lbs/csf to 2.2 lbs/csf. In one embodiment, the substrate and/or fiberglass mat has a basis weight of 1.8 lbs/csf to 2.2 lbs/csf. In one embodiment, the substrate and/or fiberglass mat has a basis weight of 1.9 lbs/csf to 2.2 lbs/csf. In one embodiment, the substrate and/or fiberglass mat has a basis weight of 2 lbs/csf to 2.2 lbs/csf. In one embodiment, the substrate and/or fiberglass mat has a basis weight of 2.1 lbs/csf to 2.2 lbs/csf. In one embodiment, the substrate and/or fiberglass mat has a basis weight of 2.15 lbs/csf to 2.2 lbs/csf. In an embodiment, the substrate and/or fiberglass mat has a basis weight of 1.6 lbs/csf to 2.15 lbs/csf. In one embodiment, the substrate and/or fiberglass mat has a basis weight of 1.7 lbs/csf to 2.15 lbs/csf. In one embodiment, the substrate and/or fiberglass mat has a basis weight of 1.8 lbs/csf to 2.15 lbs/csf. In one embodiment, the substrate and/or fiberglass mat has a basis weight of 1.9 lbs/csf to 2.15 lbs/csf. In one embodiment, the substrate and/or fiberglass mat has a basis weight of 2 lbs/csf to 2.15 lbs/csf. In one embodiment, the substrate and/or fiberglass mat has a basis weight of 2.1 lbs/csf to 2.15 lbs/csf. In an embodiment, the substrate and/or fiberglass mat has a basis weight of 1.6 lbs/csf to 2.1 lbs/csf. In one embodiment, the substrate and/or fiberglass mat has a basis weight of 1.7 lbs/csf to 2.1 lbs/csf. In one embodiment, the substrate and/or fiberglass mat has a basis weight of 1.8 lbs/csf to 2.1 lbs/csf. In one embodiment, the substrate and/or fiberglass mat has a basis weight of 1.9 lbs/csf to 2.1 lbs/csf. In one embodiment, the substrate and/or fiberglass mat has a basis weight of 2 lbs/csf to 2.1 lbs/csf. In an embodiment, the substrate and/or fiberglass mat has a basis weight of 1.6 lbs/csf to 2 lbs/csf. In one embodiment, the substrate and/or fiberglass mat has a basis weight of 1.7 lbs/csf to 2 lbs/csf. In one embodiment, the substrate and/or fiberglass mat has a basis weight of 1.8 lbs/csf to 2 lbs/csf. In one embodiment, the substrate and/or fiberglass mat has a basis weight of 1.9 lbs/csf to 2 lbs/csf. In an embodiment, the substrate and/or fiberglass mat has a basis weight of 1.6 lbs/csf to 1.9 lbs/csf. In one embodiment, the substrate and/or fiberglass mat has a basis weight of 1.7 lbs/csf to 1.9 lbs/csf. In one embodiment, the substrate and/or fiberglass mat has a basis weight of 1.8 lbs/csf to 1.9 lbs/csf. In an embodiment, the substrate and/or fiberglass mat has a basis weight of 1.6 lbs/csf to 1.8 lbs/csf. In one embodiment, the substrate and/or fiberglass mat has a basis weight of 1.7 lbs/csf to 1.8 lbs/csf. In an embodiment, the substrate and/or fiberglass mat has a basis weight of 1.6 lbs/csf to 1.7 lbs/csf.

According to one embodiment, the substrate and/or fiberglass mat (see, e.g., substrate or fiberglass mat (110) of FIG. 1) has a tensile strength in the machine direction (MD) of the roll and a tensile strength in the transverse direction (TD) of the roll, such that a ratio of the tensile strength in the machine direction of the roll relative to the tensile strength in the transverse direction of the roll is from 1:1 to 3:1. In an embodiment, the substrate and/or fiberglass mat has a tensile strength in the machine direction of the roll and a tensile strength in the transverse direction of the roll, such that a ratio of the tensile strength in the machine direction of the roll relative to the tensile strength in the transverse direction of the roll is from 1:1 to 2:1. In another embodiment, the substrate and/or fiberglass mat has a tensile strength in the machine direction of the roll and a tensile strength in the transverse direction of the roll, such that a ratio of the tensile strength in the machine direction of the roll relative to the tensile strength in the transverse direction of the roll is from 2:1 to 3:1.

According to another embodiment, the substrate and/or fiberglass mat (see, e.g., substrate or fiberglass mat (110) of FIG. 1) has a ratio of the number of fibers of the first set of fibers extending in the machine direction (MD) of the roll relative to the number of fibers of the second set of fibers extending in the transverse direction (TD) of the roll of from 1:1 to 3:1. In an embodiment, the substrate and/or fiberglass mat has a ratio of the number of fibers of the first set of fibers extending in the machine direction of the roll relative to the number of fibers of the second set of fibers extending in the transverse direction of the roll of from 1:1 to 2:1. In another embodiment, the substrate and/or fiberglass mat has a ratio of the number of fibers of the first set of fibers extending in the machine direction of the roll relative to the number of fibers of the second set of fibers extending in the transverse direction of the roll of from 2:1 to 3:1.

According to an embodiment, when the substrate and/or fiberglass mat is coated with at least one of asphalt, a polymer-modified asphalt, or a non-asphaltic polymeric coating to form a roofing material, the roofing material has a mean failure energy according to ASTM D5420 of 2 in-lbs to 4.5 in-lbs. In one embodiment, the roofing material has a mean failure energy of 2.5 in-lbs to 4.5 in-lbs. In one embodiment, the roofing material has a mean failure energy of 3 in-lbs to 4.5 in-lbs. In one embodiment, the roofing material has a mean failure energy of 3.5 in-lbs to 4.5 in-lbs. In one embodiment, the roofing material has a mean failure energy of 4 in-lbs to 4.5 in-lbs. In one embodiment, the roofing material has a mean failure energy of 2 in-lbs to 4 in-lbs. In one embodiment, the roofing material has a mean failure energy of 2.5 in-lbs to 4 in-lbs. In one embodiment, the roofing material has a mean failure energy of 3 in-lbs to 4 in-lbs. In one embodiment, the roofing material has a mean failure energy of 3.5 in-lbs to 4 in-lbs. According to an embodiment, the roofing material has a mean failure energy of 2 in-lbs to 3.8 in-lbs. In one embodiment, the roofing material has a mean failure energy of 2.5 in-lbs to 3.8 in-lbs. In one embodiment, the roofing material has a mean failure energy of 2.6 in-lbs to 3.8 in-lbs. In one embodiment, the roofing material has a mean failure energy of 3 in-lbs to 3.8 in-lbs. In one embodiment, the roofing material has a mean failure energy of 3.5 in-lbs to 3.8 in-lbs. According to an embodiment, the roofing material has a mean failure energy of 2 in-lbs to 3.5 in-lbs. In one embodiment, the roofing material has a mean failure energy of 2.5 in-lbs to 3.5 in-lbs. In one embodiment, the roofing material has a mean failure energy of 3 in-lbs to 3.5 in-lbs. According to an embodiment, the roofing material has a mean failure energy of 2 in-lbs to 3 in-lbs. In one embodiment, the roofing material has a mean failure energy of 2.5 in-lbs to 3 in-lbs. According to an embodiment, the roofing material has a mean failure energy of 2 in-lbs to 2.5 in-lbs.

In one embodiment, the fibers further comprise a third set of fibers extending in a third direction that is between the machine direction (MD) of the roll and the transverse direction (TD) of the roll (see, e.g., roll (100) of FIG. 1).

Another embodiment of this invention pertains to a roofing material comprising (a) a substrate including fibers, wherein the fibers comprise (i) a first set of fibers extending in a machine direction of a roll of the substrate, and (ii) a second set of fibers extending in a transverse direction of the roll of the substrate, with the substrate having a tensile strength in the machine direction of the roll and a tensile strength in the transverse direction of the roll, such that a ratio of the tensile strength in the machine direction relative to the tensile strength in the transverse direction is from 1:1 to 3:1, and (b) a coating applied onto the substrate, thereby forming a coated substrate.

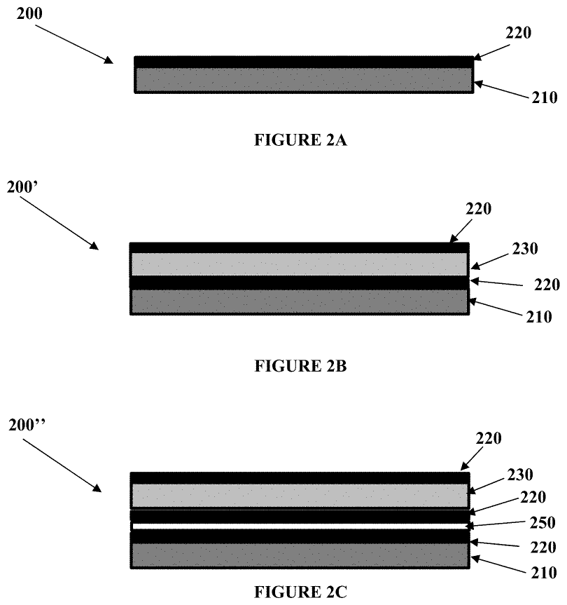

FIG. 2A illustrates a roofing material (200) comprising a substrate (210) according to an embodiment of the invention. In this embodiment, the roofing material (200) includes a single substrate (210) and a coating (220) applied onto the substrate (210) to form a coated substrate.

In an embodiment, the substrate (see, e.g., substrate (210) of FIG. 2A) comprises at least one of a scrim, a fiberglass mat or a polyester mat.

In an embodiment, the coating (see, e.g., coating (220) of FIG. 2A) comprises at least one of asphalt, a polymer-modified asphalt, or a non-asphaltic polymeric coating.

In one embodiment, the coating at least partially infiltrates the substrate.

In one embodiment, the roofing material further comprises a second substrate. According to an embodiment, the coating is applied onto both the substrate and the second substrate, thereby forming the coated substrate and a coated second substrate.

FIG. 2B illustrates a roofing material (200′) comprising a substrate (210) according to another embodiment of the invention. In this embodiment, the roofing material (200′) includes a substrate (210) and a second substrate (230). As shown in FIG. 2B, a coating (220) is applied onto both the substrate (210) and the second substrate (230) to form a coated substrate and a coated second substrate.

According to an embodiment, the second substrate (see, e.g., second substrate (230) of FIG. 2B) comprises at least one of a scrim, a fiberglass mat or a polyester mat.

According to one embodiment, the second substrate can be bonded to a first substrate which is precoated with excess asphalt to form a layered membrane. Granules can then be applied to one side and fines can be applied to the opposite side to form a composite which is then cut and laminated into a roofing material (e.g., shingles).

According to an embodiment, the addition of an extra scrim or mat layer (e.g., a second substrate) to a conventional single mat layer that is generally used in conventional shingle construction provides additional reinforcement to that of asphaltic viscoelastic and mechanical properties. According to one embodiment, separate pieces of mat and scrim can be laminated together in the asphalt coater. According to another embodiment, the substrate(s) (e.g., scrim or mat or both) can be pre-saturated with an asphalt coating and bonded together using a hot asphalt filled coating or adhesive materials. The hot asphalt filled coating may also be sprayed or roll applied onto the substrate(s) (e.g., mat or scrim or both) prior to bonding the two substrates together. According to one embodiment, the substrates (e.g., the mat and scrim) may or may not have an interlayer of coating between them prior to fully coating the system with a filled asphalt coating. The substrates (e.g., the mat and scrim) can be embedded in the asphalt filled coating with granules applied to one side and fines or any other covering cast on the opposite side of the roofing material (e.g., shingle). According to an embodiment, the second substrate and/or additional layer of scrim or mat can be made to cover the whole roofing material (e.g., shingle) or a part(s) of the roofing material where additional fortification is desired. According to embodiments of the invention, improved impact resistance performance of the roofing materials prepared according to embodiments of the invention can be achieved, as compared to conventional roofing materials (e.g., shingles), while using blown coating or polymer modified asphalt, as well as for impact resistant shingles using polymer modified shingles.

According to another embodiment, a polymer-based coating layer is positioned between the substrate and the second substrate. According to an embodiment, the coating is applied onto the substrate, the second substrate, and the polymer-based coating layer, thereby forming the coated substrate, a coated second substrate, and a coated polymer-based coating layer.

FIG. 2C illustrates a roofing material (200″) comprising a substrate (210) according to another embodiment of the invention. In this embodiment, the roofing material (200″) includes a substrate (210), a second substrate (230), and a polymer-based coating layer (250) positioned between the substrate (210) and the second substrate (230). As shown in FIG. 2C, a coating (220) is applied onto the substrate (210), the second substrate (230), and the polymer-based coating layer (250) to form a coated substrate, a coated second substrate, and a coated polymer-based coating layer.

In an embodiment, the roofing material is a roofing shingle. According to one embodiment, the roofing shingle is one of (i) a single layer shingle or (ii) a laminated shingle having two or more layers.

In an embodiment, the roofing material further includes granules. In another embodiment, the roofing material further comprises fines. According to another embodiment, granules are applied to a first side of the coated substrate and fines are applied to a second side of the coated substrate.

Another embodiment of this invention pertains to a method of preparing a roofing material that includes (a) obtaining a substrate including fibers, wherein the fibers comprise (i) a first set of fibers extending in a machine direction of a roll of the substrate, and (ii) a second set of fibers extending in a transverse direction of the roll of the substrate, with the substrate having a tensile strength in the machine direction of the roll and a tensile strength in the transverse direction of the roll, such that a ratio of the tensile strength in the machine direction relative to the tensile strength in the transverse direction is from 1:1 to 3:1, and (b) applying a coating onto the substrate to form a coated substrate of the roofing material.

In one embodiment, the method further includes obtaining a second substrate. According to an embodiment, the coating is applied onto both the substrate and the second substrate, thereby forming the coated substrate and a coated second substrate. According to another embodiment, a polymer-based coating layer is positioned between the substrate and the second substrate. According to an embodiment, the coating is applied onto the substrate, the second substrate, and the polymer-based coating layer, thereby forming the coated substrate, a coated second substrate, and a coated polymer-based coating layer.

In one embodiment, the method further includes applying granules to the coated substrate. In another embodiment, the method further includes (i) applying granules to a first side of the coated substrate and (ii) applying fines to a second side of the coated substrate.

### EXAMPLES

Specific embodiments of the invention will now be demonstrated by reference to the following examples. It should be understood that these examples are disclosed by way of illustrating the invention and should not be taken in any way to limit the scope of the present invention.

### Example 1

The improved performance of roofing materials having substrates prepared according to embodiments of the invention and with basis weights of 1.8 lbs/csf, 2 lbs/csf, and 2.15 lbs/csf, was demonstrated with respect to control roofing materials (including, e.g., shingles).

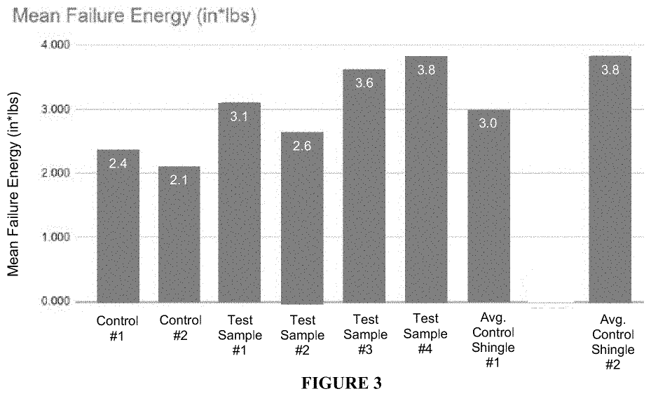

The results of this example are shown in the following Table 1 and the graph of FIG. 3, which illustrate the mean failure energy (in-lbs), respectively, of exemplary plant prepared roofing materials (“control sheets”) and lab prepared roofing materials (including, e.g., shingles or “shinglets”) having a certain mat thickness (in), a certain shinglet thickness (in), and a certain sample weight (g).

TABLE 1

| | | Basis | Avg. Mat | Avg. Shinglet | Avg. Weight | | |
|---|---|---|---|---|---|---|---|
| Sample | Type of | Weight | Thickness* | Thickness* | of Sample* | | Mean Failure |
| Name | Coating | (lb) | (in) | (in) | (g) | Directionality | Energy (in-lbs) |
| Control | Polyco | 1.8 | 0.03 | 0.1 | 8.4 | HIGH | 2.4 |
| Sheet #1 | Filled | | | | | | |
| Control | Blown | 1.8 | 0.03 | 0.1 | 8.8 | HIGH | 2.1 |
| Sheet #2 | Coating | | | | | | |
| | Filled | | | | | | |
| Test | Polyco | 1.8 | 0.04 | 0.1 | 9.3 | LOW | 3.1 |
| Sample 1 | Filled | | | | | | |
| Test | Blown | 1.8 | 0.04 | 0.1 | 9.1 | LOW | 2.6 |
| Sample 2 | Coating | | | | | | |
| | Filled | | | | | | |
| Test | Blown | 2.0 | 0.04 | 0.1 | 9.5 | LOW | 3.6 |
| Sample 3 | Coating | | | | | | |
| | Filled | | | | | | |
| Test | Blown | 2.15 | 0.04 | 0.1 | 10.4 | LOW | 3.8 |
| Sample 4 | Coating | | | | | | |
| | Filled | | | | | | |
| Average | Polyco | 1.8 | 0.03 | 0.1 | 8.9 | HIGH | 3.0 |
| Control | Filled | | | | | | |
| Plant | | | | | | | |
| Shingle #1 | | | | | | | |
| Average | Polyco | 1.8 | 0.03 | 0.1 | 9.0 | HIGH | 3.8 |
| Control | Filled | | | | | | |
| Plant | | | | | | | |
| Shingle #2 | | | | | | | |

*The average thickness and average weight of the sample were determined to not have any substantial effect on the mean failure energy.

Mean failure energy and/or impact resistance, which is based on ASTM D5420, is defined as the force or energy (in-lbs) required to produce 50% failures of a flat test specimen by means of a striker and/or falling weight. In particular, a failure of, e.g., a test specimen, is the presence of any crack or split created by the impact of the striker and/or falling weight that can be seen by the naked eye under normal laboratory conditions.

As shown in Table 1 above and the graph of FIG. 3, while the control roofing materials (e.g., “control sheets”) exhibited mean failure energy values (in-lbs) of about 2.4 in-lbs and 2.1 in-lbs, respectively, the roofing materials that were prepared with substrates according to embodiments of the invention exhibited mean failure energy values (in-lbs) of at least 2.6 in-lbs using substrates of the same or higher basis weights. In particular, as shown in Table 1 above and the graph of FIG. 3, the lab or hand sheets (“test samples”) that were prepared using substrates according to embodiments of the invention with basis weights of, for example, 1.8 lbs/csf, 2 lbs/csf, and 2.15 lbs/csf exhibited mean failure energy values (in-lbs) of 3.1 in-lbs, 2.6 in-lbs, 3.6 in-lbs, and 3.8 in-lbs, respectively. Accordingly, roofing materials that were prepared with substrates according to embodiments of the invention exhibited improved mean failure energy values (in-lbs) using substrates of the same or higher basis weights (e.g., 1.8 lbs/csf to 2.2 lbs/csf).

As further shown in Table 1 above, the control roofing materials (e.g., “control sheets”), which each had a basis weight of 1.8 lbs/csf and exhibited mean failure energy values (in-lbs) of about 2.4 in-lbs and 2.1 in-lbs, respectively, were prepared to have “high directionality” with regard to the fibers of these control roofing materials. However, the roofing materials, which were prepared with substrates according to embodiments of the invention and with “low directionality,” exhibited mean failure energy values (in-lbs) of at least 2.6 in-lbs. In particular, as shown in Table 1 above, the lab or hand sheets (“test samples”) that were prepared using substrates according to embodiments of the invention, with the same basis weight as the control roofing materials (i.e., 1.8 lbs/csf), and with “low directionality,” exhibited mean failure energy values (in-lbs) of 3.1 in-lbs and 2.6 in-lbs, respectively. Accordingly, roofing materials that were prepared with substrates according to embodiments of the invention exhibited improved mean failure energy values (in-lbs) using substrates of the same basis weight but with “low directionality.”

Table 1 above further illustrates that the type of coating used with the substrates (i.e., polyco filled versus blown coating filled) appears to impact the mean failure energy values (in-lbs). In particular, when comparing the two control roofing materials (e.g., “control sheets”), the first control sheet, which had a polyco filled coating, exhibited a mean failure energy value (in-lbs) of 2.4 in-lbs, while the second control sheet, which had a blown coating filled coating, exhibited a mean failure energy value (in-lbs) of 2.1 in-lbs. In addition, the first test sample, which had a polyco filled coating, exhibited a mean failure energy value (in-lbs) of 3.1 in-lbs, while the second test sample, which had a blown coating filled coating, exhibited a mean failure energy value (in-lbs) of 2.6 in-lbs.

As also shown in Table 1 above and the graph of FIG. 3, the roofing materials (“test samples”), which were prepared with substrates according to embodiments of the invention, were compared to average control plant shingles, which included granules, as well as a “high directionality.” As shown in the results of Table 1 above and the graph of FIG. 3, the roofing materials that were prepared with substrates according to embodiments of the invention exhibited comparable mean failure energy values (in-lbs) with respect to these average control plant shingles.

### Example 2

The improved performance of roofing materials having substrates prepared according to embodiments of the invention and with basis weights that increase from 1.8 lbs/csf to 1.9 lbs/csf to 2 lbs/csf to 2.15 lbs/csf, respectively, was demonstrated with respect to control samples having basis weights of 1.6 lbs/csf and 1.8 lbs/csf, respectively.

The results of this example are shown in the following Table 2, which illustrates the mean failure height (in) and mean failure energy (J and in-lbs), respectively, of exemplary plant prepared roofing materials (“controls”) and lab prepared roofing materials (“test samples”) having a certain thickness (in) and a certain sample weight (g).

TABLE 2

| | | Basis | Avg. | | | | |
|---|---|---|---|---|---|---|---|
| | | Weight | Thickness* | Avg. Sample | Mean Failure | Mean Failure | Mean Failure |
| Sample | Coating | (lb) | (in) | Weight* (g) | Height (in) | Energy (J) | Energy (in-lbs) |
| Control #1 | Blown | 1.6 | 0.1 | 9.2 | 5.2 | 0.3 | 2.6 |
| | Coating | | | | | | |
| Test Sample #1 | Blown | 1.8 | 0.1 | 9.1 | 5.3 | 0.3 | 2.6 |
| | Coating | | | | | | |
| Test Sample #2 | Blown | 1.9 | 0.1 | 10 | 6.1 | 0.3 | 3.1 |
| | Coating | | | | | | |
| Test Sample #3 | Blown | 2.0 | 0.1 | 9.5 | 7.3 | 0.4 | 3.6 |
| | Coating | | | | | | |
| Test Sample #4 | Blown | 2.15 | 0.1 | 10.4 | 7.5 | 0.4 | 3.8 |
| | Coating | | | | | | |
| Control #2 | Blown | 1.8 | 0.1 | 8.8 | 4.2 | 0.2 | 2.1 |
| (EN Mat) | Coating | | | | | | |
| EN Mat | Blown | 1.8 | 0.1 | 9.2 | 4.4 | 0.3 | 2.2 |
| Test Sample #1 | Coating | | | | | | |
| EN Mat | Blown | 1.9 | 0.1 | 8.9 | 4.5 | 0.3 | 3.1 |
| Test Sample #2 | Coating | | | | | | |

*The average thickness and average weight of the sample were determined to not have any substantial effect on the mean failure height and mean failure energy values.

Mean failure height (in), which is also based on ASTM D5420 that is discussed above with respect to mean failure energy, is defined as the height (in) at which a striker and/or falling weight will cause 50% failures for a flat, rigid test specimen. In particular, as discussed above, a failure of, e.g., a test specimen, is the presence of any crack or split created by the impact of the striker and/or falling weight that can be seen by the naked eye under normal laboratory conditions.

As shown in Table 2 above, roofing materials that were prepared with substrates according to embodiments of the invention exhibited mean failure energy values (J or in-lbs) of at least 0.3 J or 2.6 in-lbs using substrates of increasing basis weights. In particular, as shown in Table 2 above, the lab or hand sheets (“Test Samples #1 to #4”) that were prepared using substrates according to embodiments of the invention with basis weights of 1.8 lbs/csf, 1.9 lbs/csf, 2 lbs/csf, and 2.15 lbs/csf exhibited mean failure energy values (in-lbs) of 2.6 in-lbs, 3.1 in-lbs, 3.6 in-lbs, and 3.8 in-lbs, respectively. However, the exemplary plant prepared roofing material (“Control #1”), which was prepared with a substrate having a basis weight of 1.6 lbs/csf, only exhibited a mean failure energy value (in-lbs) of 2.6 in-lbs. Accordingly, roofing materials that were prepared with substrates according to embodiments of the invention exhibited improved mean failure energy values (J or in-lbs) using substrates of increased basis weights (e.g., 1.9 lbs/csf to 2.15 lbs/csf).

As further shown in Table 2 above, an exemplary EN mat (“Control #2”) was prepared to compare to other EN mats (“EN Mat Test Sample #1” and “EN Mat Test Sample #2”) having the same or higher basis weights (e.g., 1.8 lbs/csf versus 1.9 lbs/csf). For reference, an EN mat is produced on a mat line, e.g., in a plant, as opposed to a hand sheet, which is prepared in a lab. As shown in Table 2 above, the EN mat prepared with a higher basis weight of 1.9 lbs/csf (“EN Mat Test Sample #2”) exhibited a mean failure energy value (in-lbs) of 3.1 in-lbs, which was higher than the mean failure energy values (in-lbs) of 2.1 in-lbs and 2.2 in-lbs, respectively, of the EN mats prepared with a lower basis weight of 1.8 lbs/csf (“Control #2” and “EN Mat Test Sample #1”). Accordingly, as shown above, roofing materials that were prepared with substrates according to embodiments of the invention exhibited improved mean failure energy values (J or in-lbs) using substrates of an increased basis weight (e.g., 1.9 lbs/csf).

### Example 3

The improved performance of roofing materials having substrates prepared according to embodiments of the invention and with low directionality and/or a different coating (i.e., a PMA coating) was demonstrated with respect to control samples having high directionality and/or a different coating (i.e., a blown coating).

The results of this example are shown in the following Table 3, which illustrates the mean failure height (in) and mean failure energy (J and in-lbs), respectively, of exemplary plant prepared roofing materials (“controls”) and lab prepared roofing materials (“test samples”) having a certain thickness (in) and a certain sample weight (g).

TABLE 3

| | | | | | Avg. | Mean | Mean | Mean |
|---|---|---|---|---|---|---|---|---|
| | | Basis | | Avg. | Sample | Failure | Failure | Failure |
| | | Weight | | Thickness* | Weight* | Height | Energy | Energy |
| Sample | Ceating | (lb) | Directionality | (in) | (g) | (in) | (J) | (in-lbs) |
| Control #l | Blown | 1.8 | HIGH | 0.1 | 8.8 | 4.2 | 0.2 | 2.1 |
| (EN Mat) | Coating | | | | | | | |
| Control #2 | Blown | 1.8 | HIGH | 0.1 | 9.2 | 4.4 | 0.3 | 2.2 |
| (EN Mat) | Coating | | | | | | | |
| EN Mat | PMA Coating | 1.8 | HIGH | 0.1 | 8.4 | 4.8 | 0.3 | 2.4 |
| Test Sample #1 | | | | | | | | |
| EN Mat | PMA Coating | 1.8 | HIGH | 0.1 | 9.8 | 5.9 | 0.3 | 2.9 |
| Test Sample #2 | | | | | | | | |
| Test Sample #1 | Blown | 1.8 | LOW | 0.1 | 9.1 | 5.3 | 0.3 | 2.6 |
| | Coating | | | | | | | |
| Test Sample #2 | PMA Coating | 1.8 | LOW | 0.1 | 9.3 | 6.2 | 0.4 | 3.1 |

*The average thickness and average weight of the sample were determined to not have any substantial effect on the mean failure height and mean failure energy values.

As shown in Table 3 above, the control roofing materials (i.e., “Control #1” and “Control #2”), which each had a basis weight of 1.8 lbs/csf, a blown coating, and exhibited mean failure energy values (in-lbs) of about 2.1 in-lbs and 2.2 in-lbs, respectively, were prepared to have “high directionality” with regard to the fibers of these control roofing materials. However, the roofing materials, which were also prepared with substrates having “high directionality,” but with a PMA coating, exhibited higher mean failure energy values (in-lbs). In particular, as shown in Table 3 above, the EN mat samples (i.e., “EN Mat Test Sample #1” and “EN Mat Test Sample #2”) that were prepared using substrates with the same basis weight as the control roofing materials (i.e., 1.8 lbs/csf) and with “high directionality,” but with a PMA coating, exhibited mean failure energy values (in-lbs) of 2.4 in-lbs and 2.9 in-lbs, respectively. Accordingly, roofing materials that were prepared with substrates according to embodiments of the invention exhibited improved mean failure energy values (in-lbs) using substrates of the same basis weight but with a PMA coating.

Table 3 above further illustrates that roofing materials, which were prepared with substrates according to embodiments of the invention and with “low directionality,” exhibited mean failure energy values (in-lbs) of at least 2.6 in-lbs. In particular, as shown in Table 3 above, the lab or hand sheets (i.e., “Test Sample #1” and “Test Sample #2”) that were prepared using substrates according to embodiments of the invention, with the same basis weight as the control roofing materials (i.e., 1.8 lbs/csf), and with “low directionality,” exhibited mean failure energy values (in-lbs) of 2.6 in-lbs and 3.1 in-lbs, respectively. Accordingly, roofing materials that were prepared with substrates according to embodiments of the invention exhibited improved mean failure energy values (in-lbs) using substrates of the same basis weight but with “low directionality.” Moreover, the roofing material that was prepared using a substrate according to embodiments of the invention, with the same basis weight as the control roofing materials (i.e., 1.8 lbs/csf), and with “low directionality,” but with a PMA coating (i.e., “Test Sample #2”) exhibited the highest mean failure energy value (in-lbs) for this Example of 3.1 in-lbs. Thus, a roofing material that was prepared with a substrate according to embodiments of the invention exhibited an improved mean failure energy value (in-lbs) using a substrate of the same basis weight but with “low directionality” and a PMA coating.

### Example 4

The performance of a roofing material having a substrate prepared according to embodiments of the invention, with a different type of fiber (i.e., a longer T fiber), and with a basis weight of 1.9 lbs/csf was demonstrated with respect to an exemplary control sample (“Control #1”) having the same basis weight (i.e., 1.9 lbs/csf), but using M fibers. For reference, M fibers are around 15.2 to 16.5 microns in diameter, while the longer T fibers are around 22.9 to 24.1 microns in diameter.

The results of this example are shown in the following Table 4, which illustrates the mean failure height (in) and mean failure energy (J and in-lbs), respectively, of exemplary plant prepared and lab prepared roofing materials having a certain thickness (in) and a certain sample weight (g).

TABLE 4

| | | | | | | Avg. | Mean | Mean | Mean |
|---|---|---|---|---|---|---|---|---|---|
| | | Basis | | | Avg. | Sample | Failure | Failure | Failure |
| | | Weight | Fiber | Number | Thickness* | Weight* | Height | Energy | Energy |
| Sample | Coating | (lb) | Type | of Mats | (in) | (g) | (in) | (J) | (in-lbs) |
| Control #1 | Blown | 1.9 | M Fiber | 1 | 0.1 | 10 | 6.1 | 0.3 | 3.1 |
| | Coating | | | | | | | | |
| Test | Blown | 1.9 | Longer | 1 | 0.1 | 9.2 | 5.5 | 0.3 | 2.8 |
| Sample #1 | Coating | | T Fiber | | | | | | |

*The average thickness and average weight of the sample were determined to not have any substantial effect on the mean failure height and mean failure energy values.

As shown in Table 4 above, the control roofing material (i.e., “Control #1”), which had a basis weight of 1.9 lbs/csf, a blown coating, and exhibited a mean failure energy value (in-lbs) of about 3.1 in-lbs, was prepared using M fibers. However, the roofing material, which was also prepared with a substrate having a basis weight of 1.9 lbs/csf and a blown coating, but with longer T fibers, exhibited a lower mean failure energy value (in-lbs). In particular, as shown in Table 4 above, the lab or hand sheet sample (i.e., “Test Sample #1”) that was prepared using a substrate with the same basis weight as the control roofing material (i.e., 1.9 lbs/csf) and with a blown coating, but with longer T fibers, exhibited a mean failure energy value (in-lbs) of 2.8 in-lbs. Accordingly, roofing materials that were prepared with substrates according to embodiments of the invention did not exhibit improved mean failure energy values (in-lbs) using substrates having a different type of fiber (e.g., longer T fibers).

### Example 5

The improved performance of roofing materials having substrates prepared according to embodiments of the invention and with a basis weight of 1.6 lbs/csf, was demonstrated with respect to a sample having two mats/substrates and a sample prepared with a PVB blown coating.

The results of this example are shown in the following Table 5, which illustrates the mean failure height (in) and mean failure energy (J and in-lbs), respectively, of exemplary plant prepared and lab prepared roofing materials having a certain thickness (in) and a certain sample weight (g).

TABLE 5

| | | | | | | Avg. | Mean | Mean | Mean |
|---|---|---|---|---|---|---|---|---|---|
| | | Basis | | | Avg. | Sample | Failure | Failure | Failure |
| | | Weight | Fiber | Number | Thickness* | Weight* | Height | Energy | Energy |
| Sample | Coating | (lb) | Type | of Mats | (in) | (g) | (in) | (J) | (in-lbs) |
| Control #1 | Blown | 1.8 | M Fiber | 1 | 0.1 | 8.8 | 4.2 | 0.2 | 2.1 |
| (EN Mat) | Coating | | | | | | | | |
| EN Mat | Blown | 1.63 | M Fiber | 2 | 0.1 | 11.2 | 9.1 | 0.5 | 4.5 |
| Test Sample #1 | Coating | | | | | | | | |
| EN Mat | Blown | 1.63 | M Fiber | 1 | 0.1 | 9.6 | 4.6 | 0.3 | 2.3 |
| Test Sample #2 | Coating | | | | | | | | |
| | with PVB | | | | | | | | |
| | Spray | | | | | | | | |

*The average thickness and average weight of the sample were determined to not have any substantial effect on the mean failure height and mean failure energy values.

As shown in Table 5 above, the control roofing material (i.e., “Control #1”), which had a basis weight of 1.8 lbs/csf, a blown coating, and exhibited a mean failure energy value (in-lbs) of about 2.1 in-lbs, was prepared using M fibers and a single mat. However, the roofing material, which was prepared with a substrate having a basis weight of 1.63 lbs/csf, a blown coating, and M fibers, but with two mats, exhibited a higher mean failure energy value (in-lbs). In particular, as shown in Table 5 above, the lab prepared sample (i.e., “EN Mat Test Sample #1”) that was prepared using a substrate with a lower basis weight as the control roofing material (i.e., 1.63 lbs/csf versus 1.8 lbs/csf) and with a blown coating, but with two mats, exhibited a mean failure energy value (in-lbs) of 4.5 in-lbs. Accordingly, roofing materials that were prepared with substrates according to embodiments of the invention exhibited improved mean failure energy values (in-lbs) using substrates having two mats.

As also shown in Table 5 above, the roofing material, which was prepared with a substrate having a basis weight of 1.63 lbs/csf, a single mat, and M fibers, but with a blown coating having a PVB spray, exhibited a higher mean failure energy value (in-lbs) as compared to the control sample. In particular, as shown in Table 5 above, the second lab prepared sample (i.e., “EN Mat Test Sample #2”) that was prepared using a substrate with a basis weight of 1.63 lbs/csf and a single mat, but with a blown coating having a PVB spray, exhibited a mean failure energy value (in-lbs) of 2.3 in-lbs. Accordingly, roofing materials that were prepared with substrates according to embodiments of the invention exhibited improved mean failure energy values (in-lbs) using substrates having a blown coating but with a PVB spray.

### Example 6

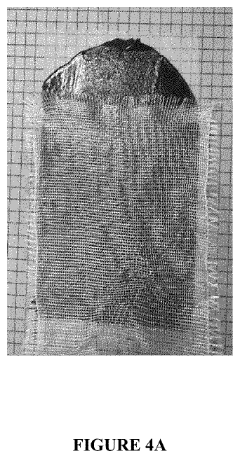

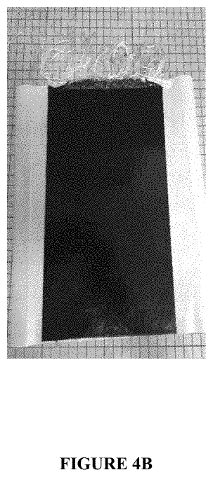

Samples were prepared to construct lab shinglet prototypes using a scrim and/or mat (e.g., substrate) that is combined with another scrim and/or mat (e.g., second substrate) in order to compare these samples with a control lab shinglet prototype using only a single scrim and/or mat (e.g., substrate). A first sample (“Sample A”) was prepared with a single fiberglass mat having a filled asphalt coating and fines applied to the top (Sample A is shown in FIG. 4A and FIG. 5A). A second and third sample (“Sample B” and “Sample C”) were prepared using a scrim that was combined with a fiberglass mat, which were then coated with a filled asphalt coating and fines were applied to the top (Sample B is shown in FIGS. 4B-4C and FIG. 5B).

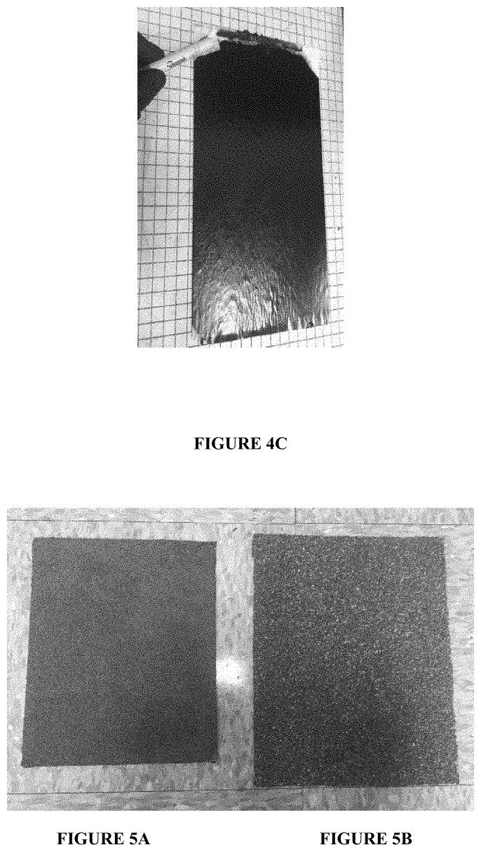

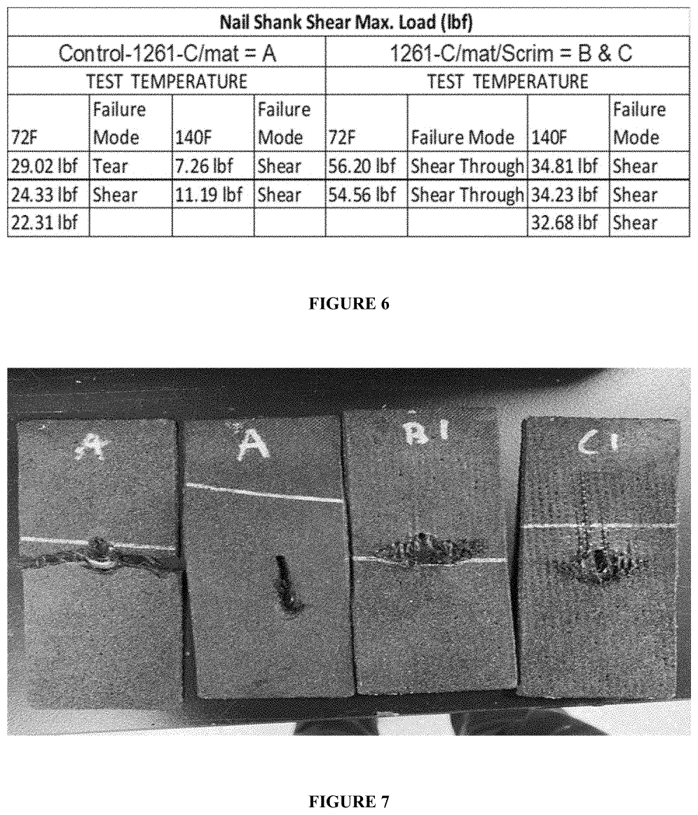

The results of this example are shown in the table of FIG. 6 and the photograph of FIG. 7, which illustrate the nail pull through/tear of each of the prepared Samples A, B, and C. As shown in the results of the table of FIG. 6, Sample A, which was prepared with only a single fiberglass mat as the substrate, exhibited failure by nail tear and/or shear (lbf) at lower values at either 72° F. or 140° F., as compared to the values for nail tear and/or shear (lbf) at the same temperatures for Samples B and C, which were prepared with both a scrim and a fiberglass mat to create a prototype having two substrates.

### Example 7

Samples were prepared to construct lab shinglet prototypes using a scrim and/or mat (e.g., substrate) that is combined with another scrim and/or mat (e.g., second substrate) in order to compare these samples with a control lab shinglet prototype using only a single mat (e.g., substrate). Three samples were prepared with an asphalt filled coating as follows: (i) a single fiberglass mat having an asphalt filled coating and granules applied to the top (“Control #1”); (ii) a scrim that was combined with a fiberglass mat, which were then coated with an asphalt filled coating and granules were applied to the top; and (iii) two fiberglass mats were combined, which were then coated with an asphalt filled coating and granules were applied to the top. Three other samples were prepared with a polymer-modified asphalt (PMA) filled coating as follows: (i) a single fiberglass mat having a PMA filled coating and granules applied to the top (“Control #2”); (ii) a scrim that was combined with a fiberglass mat, which were then coated with a PMA filled coating and granules were applied to the top; and (iii) two fiberglass mats were combined, which were then coated with a PMA filled coating and granules were applied to the top.

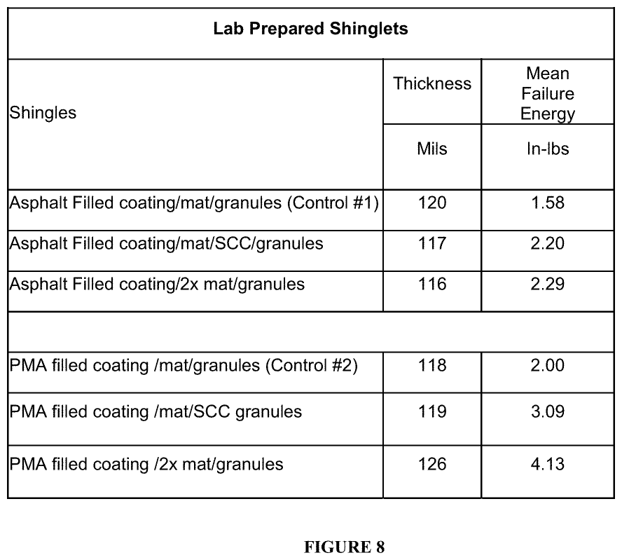

The results of this example are shown in the table of FIG. 8, which illustrates the thickness (mils) of each of the prepared samples, along with their respective mean failure energy values (in-lbs), which were tested according to ASTM D5420. As shown in the results of the table of FIG. 8, each of the samples that were prepared using (i) a mat in combination with a scrim or (ii) two fiberglass mats exhibited improved/increased values for impact resistance and/or mean failure energy (in-lbs), as compared to the samples prepared with only a single fiberglass mat.

Although the invention has been described in certain specific exemplary embodiments, many additional modifications and variations would be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

We claim:

1. A roll comprising:
a fiberglass mat,
wherein the fiberglass mat comprises a plurality of fibers, with the plurality of fibers comprising (i) a first set of fibers extending in a machine direction of the roll, and (ii) a second set of fibers extending in a transverse direction of the roll,
wherein the fiberglass mat has a basis weight of 1.6 lbs/csf to 2.2 lbs/csf,
wherein the fiberglass mat has a tensile strength in the machine direction of the roll and a tensile strength in the transverse direction of the roll, such that a ratio of the tensile strength in the machine direction of the roll relative to the tensile strength in the transverse direction of the roll is from 1:1 to 3:1, and
wherein, when the fiberglass mat is coated with at least one of asphalt, a polymer-modified asphalt, or a non-asphaltic polymeric coating to form a roofing material, the roofing material has a mean failure energy according to ASTM D5420 of 2 in-lbs to 4.5 in-lbs.

2. The roll of fiberglass mat according to claim 1, wherein the roofing material has a mean failure energy of 2.5 in-lbs to 4 in-lbs.

3. The roll of fiberglass mat according to claim 1, wherein the roofing material has a mean failure energy of 2.6 in-lbs to 3.8 in-lbs.

4. The roll of fiberglass mat according to claim 1, wherein the substrate has a basis weight of 1.8 lbs/csf to 2.15 lbs/csf.

5. The roll of fiberglass mat according to claim 1, wherein the fibers further comprise a third set of fibers extending in a third direction that is between the machine direction of the roll of fiberglass mat and the transverse direction of the roll of fiberglass mat.

6. A roll comprising:
a fiberglass mat,
wherein the fiberglass mat comprises a plurality of fibers, with the plurality of fibers comprising (i) a first set of fibers extending in a machine direction of the roll, and (ii) a second set of fibers extending in a transverse direction of the roll,
wherein the fiberglass mat has a basis weight of 1.6 lbs/csf to 2.2 lbs/csf,
wherein the fiberglass mat has a ratio of the number of fibers of the first set of fibers extending in the machine direction of the roll relative to the number of fibers of the second set of fibers extending in the transverse direction of the roll of from 1:1 to 3:1, and
wherein, when the fiberglass mat is coated with at least one of asphalt, a polymer-modified asphalt, or a non-asphaltic polymeric coating to form a roofing material, the roofing material has a mean failure energy according to ASTM D5420 of 2 in-lbs to 4.5 in-lbs.

7. The roll of fiberglass mat according to claim 6, wherein the roofing material has a mean failure energy of 2.5 in-lbs to 4 in-lbs.

8. The roll of fiberglass mat according to claim 6, wherein the substrate has a basis weight of 1.8 lbs/csf to 2.15 lbs/csf.

9. The roll of fiberglass mat according to claim 6, wherein the fibers further comprise a third set of fibers extending in a third direction that is between the machine direction of the roll of fiberglass mat and the transverse direction of the roll of fiberglass mat.

10. A roofing material comprising:
(a) a substrate including fibers, wherein the fibers comprise (i) a first set of fibers extending in a machine direction of a roll of the substrate, and (ii) a second set of fibers extending in a transverse direction of the roll of the substrate, with the substrate having a tensile strength in the machine direction of the roll and a tensile strength in the transverse direction of the roll, such that a ratio of the tensile strength in the machine direction relative to the tensile strength in the transverse direction is from 1:1 to 3:1; and
(b) a coating applied onto the substrate, thereby forming a coated substrate,
wherein the substrate has a basis weight of 1.6 lbs/csf to 2.2 lbs/csf, and
wherein the roofing material has a mean failure energy according to ASTM D5420 of 2 in-lbs to 4.5 in-lbs.

11. The roofing material according to claim 10, wherein the roofing material has a mean failure energy of 2.5 in-lbs to 4 in-lbs.

12. The roofing material according to claim 10, wherein the substrate has a basis weight of 1.8 lb/csf to 2.15 lb/csf.

13. The roofing material according to claim 10, wherein the substrate comprises at least one of a scrim, a fiberglass mat or a polyester mat.

14. The roofing material according to claim 10, wherein the coating comprises at least one of asphalt, a polymer-modified asphalt, or a non-asphaltic polymeric coating.

15. The roofing material according to claim 10, wherein the coating at least partially infiltrates the substrate.

16. The roofing material according to claim 10, further comprising a second substrate.

17. The roofing material according to claim 16, wherein the coating is applied onto both the substrate and the second substrate, thereby forming the coated substrate and a second coated substrate.

18. The roofing material according to claim 16, further comprising a polymer-based coating layer positioned between the substrate and the second substrate.

19. The roofing material according to claim 18, wherein the coating is applied onto the substrate, the second substrate, and the polymer-based coating layer, thereby forming the coated substrate, a coated second substrate, and a coated polymer-based coating layer.

20. The roofing material according to claim 10, wherein the roofing material is a roofing shingle.

21. The roofing material according to claim 20, wherein the roofing shingle is one of (i) a single layer shingle or (ii) a laminated shingle having two or more layers.

22. The roofing material according to claim 10, further comprising granules.

23. The roofing material according to claim 22, further comprising fines.

24. The roofing material according to claim 23, wherein the granules are applied to a first side of the coated substrate and the fines are applied to a second side of the coated substrate.
